(19) United States
(12) Patent Application Publication
(10) Pub. No.: US 2009/0163067 A1
(43) Pub. Date: Jun. 25, 2009

(54) Cable connector

(75) Inventor: Toshihiro Niitsu, Tokyo (JP)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/152,719

(22) Filed: May 16, 2008

(30) Foreign Application Priority Data
May 17, 2007 (JP) 2007-131125

(51) Int. Cl. H01R 13/62

(52) U.S. Cl. 439/329

(57) ABSTRACT

A cable connector includes a housing into which a cable may be inserted. A plurality of terminals are mounted on the housing and include an elastically-deformable arm portion with a free end section and a distal end section; and an actuator mounted on the housing and movable between a first operative position and a second operative position wherein the actuator urges the contact portion of each terminal towards the cable upon insertion of said cable into said insertion opening and movement of said actuator from said first operative position to said second operative position.

### BACKGROUND OF THE INVENTION

The present invention relates to a cable connector. Conventionally, a connector for connecting a flat plate-like cable such as a flexible circuit board, a flexible flat cable or the like has been proposed (refer to, for example, Japanese Patent Application Laid-Open (Kokai) publication No. S63-218175).

FIGS. 13A and 13B are cross-sectional views of one conventional cable connector.

In FIGS. 13A and 13B, reference numeral 801 designates a body portion which is formed of an insulating material and includes a receiving portion 804 into which a circuit board 807 is inserted. To the body portion 801, distal ends of terminals 802 formed of a conductive material are fixedly secured, and a movable portion 803 is pivotably connected. In each of the terminals 802, a projecting portion 805 to be connected to the circuit board 807 is formed, and a projection 806 to come into contact with each of the terminals 802 at a position in the vicinity of a free end thereof is formed in a free end of the movable portion 803.

When connecting the circuit board 807 to the connector, the circuit board 807 is inserted into the receiving portion 804 in a state where the movable portion 803 is at an open position as shown in FIG. 13A, and thereafter, the movable portion 803 is pivoted so as to be brought to a closed position as shown in FIG. 13B. Therefore, the terminals 802 are electrically connected to the circuit board 807.

However, in the described conventional connector, a large force is necessary in order to elastically deform the terminals 802, and a repulsive force which the body portion 801 and the movable portion 803 receive becomes large, which causes a necessity of increasing the sizes of the body portion 801 and the movable portion 803 so as to enhance the physical strength thereof. This makes it difficult to miniaturize the connector. Moreover, when a large number of terminals 802 must be arrayed, the dimension of the movable portion 803 in the width direction thereof (the direction perpendicular to the drawing sheet in which are shown FIGS. 13A and 13B) increases, and therefore, the movable portion 803 is apt to be deformed. Of course, an increase in the strength of the movable portion 803 can prevent any deformation thereof, and, in that case, however, the thickness of the movable portion 803 increases, and the size of the connector necessarily increases.

### SUMMARY OF THE INVENTION

Therefore, it is an object of the invention to solve the problems encountered by the conventional connector described above, and to provide a connector in which a force applied to an actuator is reduced as well as dispersed by an effective use of elasticity of end side portions of the terminals per se in a manner such that each terminal is urged toward a cable, whereby the cable may be connected easily and without failure even with a simple structure. In addition, deformation of the actuator can be prevented, and a multi-way construction can be realized due to an increase in the width thereof accompanied by realization of thin and small size of the connector.

Therefore, a cable connector according to the present invention comprises: a housing provided with an insertion opening into which a cable is inserted; terminals mounted in the housing to be electrically connectable to conductive leads of the cable; and an actuator attached to the housing to be capable of changing an attitude thereof between a first position where the cable can be inserted/removed, and a second position where the conductive leads of the cable and the terminals are electrically connected to one another, wherein the actuator urges the terminals towards the cable by an use of elasticity exhibited by end side portions of the terminals.

In the cable connector according to another embodiment of the present invention, each of the terminals is provided with a distal end portion held by the housing, and an elastically-deformable arm portion connected to the distal end portion and extending in the insertion opening, the arm portion including a contact portion protruding towards the cable that is inserted in the insertion opening, and a free end portion located at an extreme end thereof, and a ratio of a distance from the free end portion to the cable to a distance from the contact portion to the cable is configured to be equal to or larger than a ratio of a length from a front surface of a back wall portion to the free end portion to a length from the front surface of the back wall portion to the contact portion in each of the terminals.

In the cable connector according to a further embodiment of the present invention, the actuator comes into contact with the free end portions of the arm portions to apply an urging effect to the terminals.

In the cable connector according to a still further embodiment of the present invention, each of the arm portions includes a distal end-side arm portion which is comprised of a portion located closer to the distal end portion than the contact portion and is extended in an insertion/removal direction of the cable, and a free end-side arm portion which is comprised of a portion located closer to an end thereof than the contact portion and is sloped relative to the insertion/removal direction of the cable.

In the cable connector according to a still further embodiment of the present invention, the actuator is provided with a pivotal shaft, the pivotal shaft being supported by a bottom surface of the distal end-side arm portion when the actuator is at the second position.

In the cable connector according to a still further embodiment of the present invention, the actuator is provided with a pivotal shaft for allowing the actuator to be pivotally moved thereby changing the attitude thereof between the first position and the second position, and the pivotal shaft supports, together with the distal end-side arm portions, a repulsive force generated when the actuator at the second position applies an urging effect to the free end portions of the terminals.

In accordance with the present invention, the connector urges the electrodes towards the cable by the use of the elasticity exhibited by the end side portions of the respective terminals. Hence, a force applied to the actuator can be reduced and dispersed. Furthermore, since there is provided such a configuration that the pivotal shaft of the actuator is pressed down, over its length along a direction of the pivotal shaft per se, by the distal end-side arm portions of the respective terminals, the whole actuator can be reluctant to be buckled when the actuator comes to the closed position thereof. Therefore, in spite of the simplified structure of the connector, the cable can be easily and surely connected to the connector per se without causing any deformation of the actuator. Further, it is possible to increase the width of the connector so as to attain a multi-way construction while effecting a reduction in the thickness and the size of the connector.

### BRIEF DESCRIPTION OF THE DRAWINGS

FIG. 1 is a perspective view of a connector according to an embodiment of the present invention;

FIG. 2 is a top plan view of the connector according to the embodiment of the present invention;

FIG. 3 is a front view showing a portion of the connector according to the embodiment of the present invention;

FIG. 4 is a first cross-sectional view of the connector according to the embodiment of the present invention, taken along the arrow X-X of FIG. 3;

FIG. 5 is a second cross-sectional view of the connector according to the embodiment of the present invention, taken along the arrow Y-Y of FIG. 3;

FIGS. 6A, 6B, and 6C are three-views illustrating an actuator according to the embodiment of the present invention, in which FIG. 6A is a perspective view, FIG. 6B is a top plan view, and FIG. 6C is a bottom surface view;

FIG. 7 is a plan view of a flat plate-like cable according to the embodiment of the present invention;

FIG. 8 is a plan view showing a state where the flat plate-like cable is inserted in the connector according to the embodiment of the present invention;

FIG. 9 is a cross-sectional view, taken along the arrow X-X of FIG. 3, showing the state where the flat plate-like cable is inserted in the connector according to the embodiment of the present invention;

FIG. 10 is a first cross-sectional view, taken along the arrow X-X of FIG. 3, showing the state where the flat plate-like cable is connected to the connector according to the embodiment of the present invention;

FIG. 11 is a second cross-sectional view, taken along the arrow Y-Y of FIG. 3, showing the state where the flat plate-like cable is connected to the connector according to the embodiment of the present invention;

FIG. 12 is a cross-sectional view taken along the arrow Z-Z of FIG. 10; and

FIGS. 13A and 13B are cross-sectional views of a conventional cable connector.

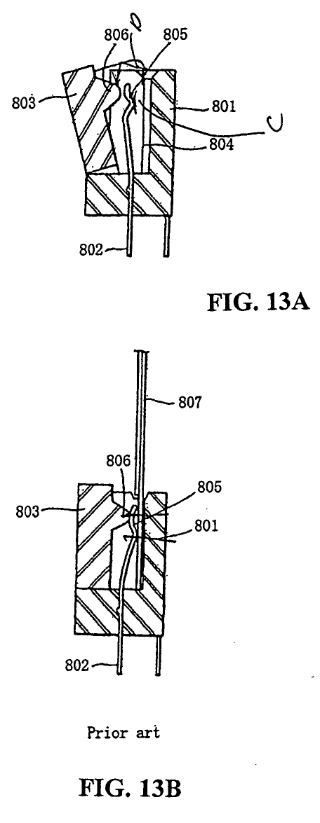

### DESCRIPTION OF THE PREFERRED EMBODIMENT

A preferred embodiment of the present invention will be described hereinbelow in detail with reference to the accompanying drawings.

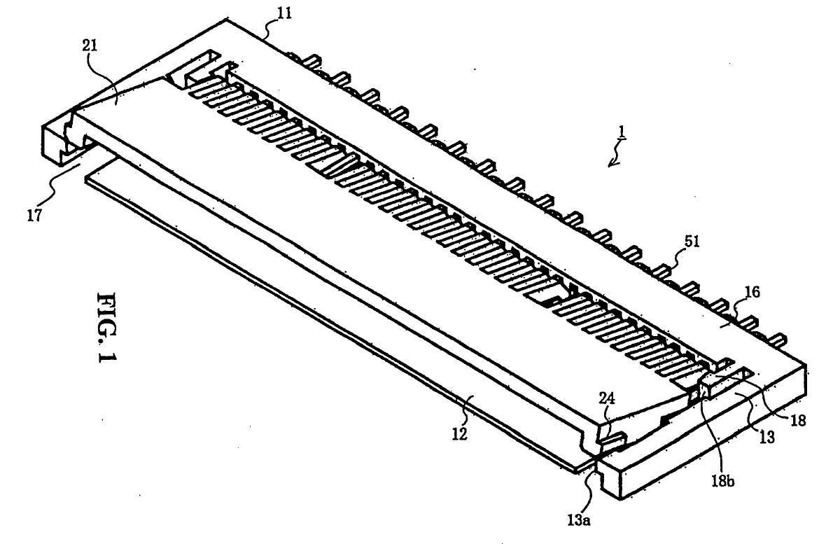

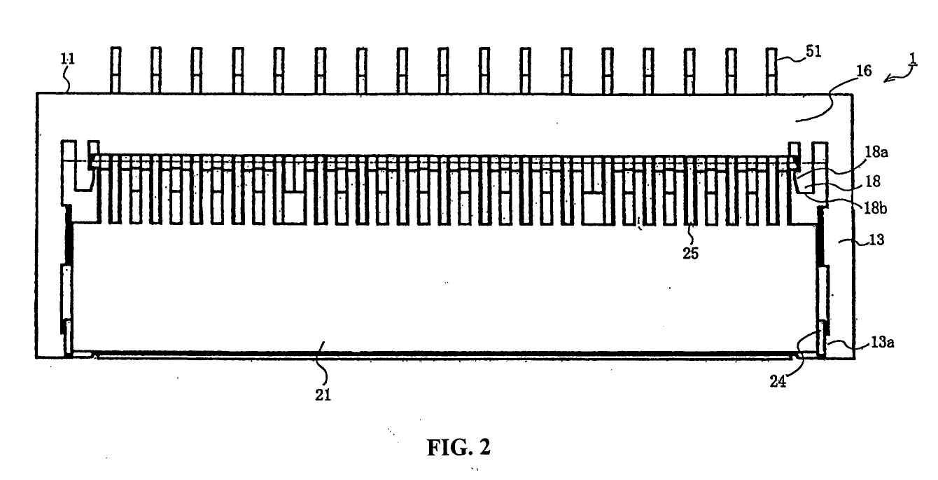

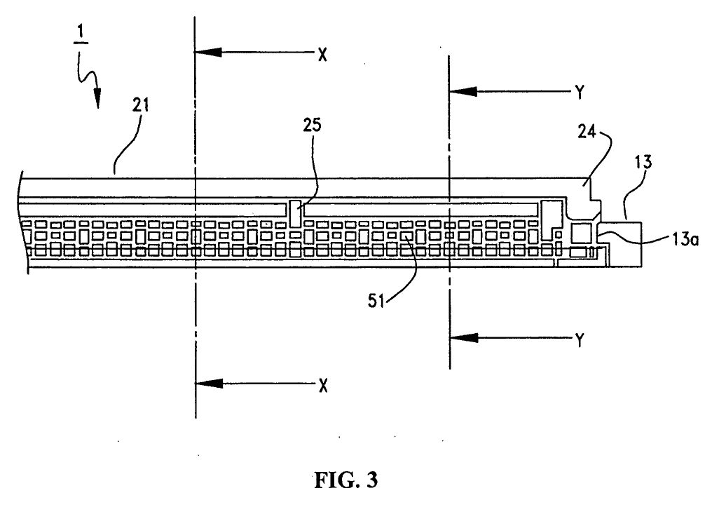

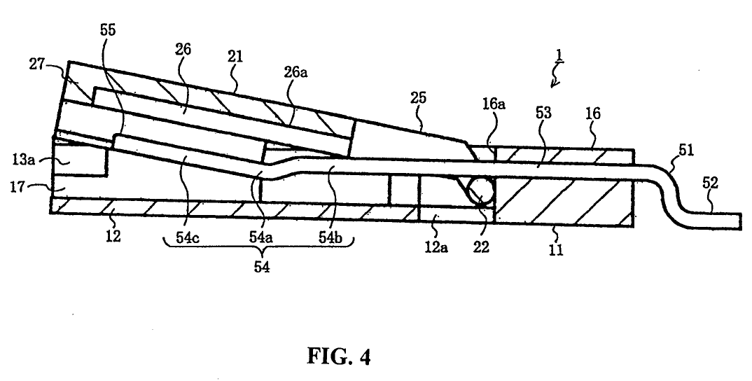

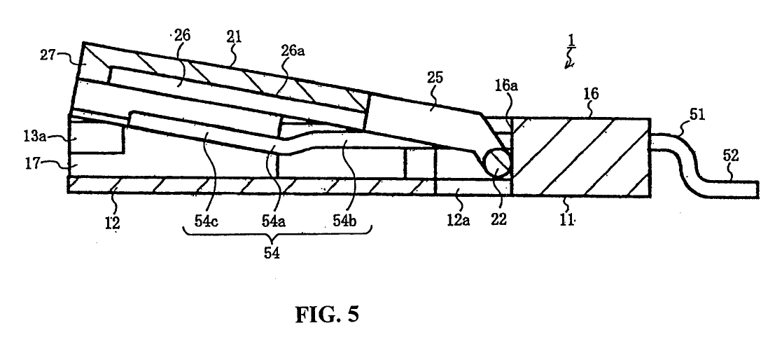

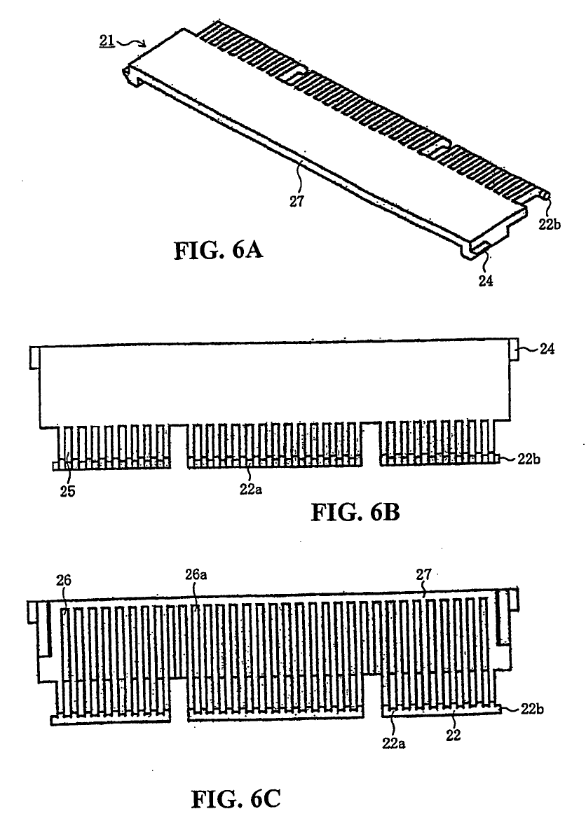

FIG. 1 is a perspective view of a connector according to an embodiment of the present invention, FIG. 2 is a top plan view of the connector according to the embodiment of the present invention, FIG. 3 is a front view showing a portion of the connector according to the embodiment of the present invention, FIG. 4 is a first cross-sectional view of the connector according to the embodiment of the present invention, taken along the arrow X-X of FIG. 3, FIG. 5 is a second cross-sectional view of the connector according to the embodiment of the present invention, taken along the arrow Y-Y of FIG. 3, and FIGS. 6A, 6B, and 6C are views showing an actuator according to the embodiment of the present invention, wherein FIG. 6A is a perspective view, FIG. 6B is a top plan view, and FIG. 6C is a bottom surface view.

In the drawings, reference numeral 1 generally denotes a connector as a cable connector according to an embodiment, which is used to connect a flat plate-like cable 101 which is later described as a cable. The flat plate-like cable 101 is a flat plat-shaped flexible cable called as, for example, a flexible printed circuit (FPC) or a flexible flat cable (FFC), but it may be any type of cable as long as it is flat plate-like and has conductive leads.

In this embodiment, representations of directions such as up, down, left, right, front, rear, and the like, used for explaining the structure and movement of each part of the connector 1, and the like, are not absolute, but relative. These representations are appropriate when each part of the connector 1, and the like, is in the position shown in the figures. If the position of the connector 1, and the like, changes, however, it is assumed that these representations are to be changed according to the change in the position of the connector 1, and the like.

The connector 1 includes a housing 11, which is integrally formed of an insulating material such as synthetic resin, and an actuator 21, which is integrally formed of an insulating material such as synthetic resin as well, and mounted on the housing 11 to be changeable in its attitude. In other words, the actuator 21 is attached to the housing 11 so that the attitude thereof changes to an open position defined as a first position, and to a closed position defined as a second position. FIGS. 1 to 5 depict the state where the actuator 21 is at the open position.

The housing 11 includes a substrate portion 12 which is a rectangle plate member and faces one surface of the flat plate-like cable 101, side wall portions 13 which are provided on opposite sides of the substrate portion 12 in a standing manner, extend in an insertion/removal direction of the flat plate-like cable 101 (the horizontal direction in FIGS. 4 and 5), and are parallel with each other, and a back wall portion 16 which is provided at one side end of the backmost (the right side in FIGS. 4 and 5) of the substrate portion 12 in a standing manner, and connects end portions of the side wall portions 13 on the opposite sides. The substrate portion 12, the side wall portions 13, and the back wall portion 16 are integrally formed as one part. An accommodating space 17, serving as an insertion opening into which an end portion of the flat plate-like cable 101 is inserted from the front (the left side in FIGS. 4 and 5), is defined by the substrate portion 12, the side wall portions 13, and the back wall portion 16. In the substrate portion 12, an opening portion 12a is formed in a portion thereof adjacent to the back wall portion 16.

Further, on the inner side of the respective side wall portions 13, auxiliary extending portions 18 are formed so as to extend towards the front from the back wall portion 16. Front end surfaces of auxiliary extending portions 18b provided in the front of the auxiliary extending portions 18 come into contact with the front end of the flat plate-like cable 101 when the latter is inserted into the accommodating space 17, thus positioning the flat plate-like cable 101 in the insertion/removal direction thereof.

Thereafter, hook portions 18a formed in the auxiliary extending portions 18 are provided for restricting movements of the actuator 21 towards the front.

Each of terminals 51 extends in the insertion/removal direction of the flat plate-like cable 101, and includes a tail portion 52 which is formed of a conductive material with elasticity, such as metal including phosphor bronze, and is connected to a surface of a not-illustrated circuit board such as a printed circuit board as a soldering portion, a distal end portion 53 held by the back wall portion 16, and an arm portion 54 extending into the accommodating space 17. A plurality of, for example, 17 of the terminals 51 are arrayed so as to be parallel with each other, and the distal end portions 53 thereof are integrally held by the back wall portion 16. The interval between the neighboring terminals 51, in other words, the pitch of the terminals 51 is, for example, approximately 0.1 [mm]. The number and pitch of the terminals 51 may be appropriately changed corresponding to the number and pitch of conductive leads 151 of the flat plate-like cable 101.

Each of the tail portions 52 protrudes backward from the back wall portion 16. Since the tail portion 52 is connected to the surface of the circuit board by soldering or the like, the tail portion 52 is connected to the distal end portion 53 via a crank-like step portion so that the bottom end surface thereof is positioned at the same level as or lower than the bottom surface of the housing 11. Moreover, the distal end portion 53 extends in parallel with the top surface of the substrate portion 12. The arm portion 54 is provided with a contact portion 54a formed to project downward in the middle thereof, a distal end section 54b which is a portion closer to the distal end portion 53 than the contact portion 54a, and extends in approximately parallel with the top surface of the substrate portion 12, and a free end section 54c which is closer to an end, in other words, an free end portion 55, than the contact portion 54a, and is sloped with respect to the top surface of the substrate portion 12 so that the free end portion 55 is inclined upward. In other words, the arm portion 54 is formed to have a cantilever-like form in which a connecting portion to the distal end portion 53 is fixedly arranged, the distal end section 54b is approximately parallel with the top surface of the substrate portion 12, the contact portion 54a is closer to the top surface of the substrate portion 12, and the end of the free end section 54c, in other words, the free end portion 55 is largely separated apart from the top surface of the substrate portion 12.

As shown in FIG. 6, the actuator 21 is a thick plate-like member having an approximately quadrate shape, and is operated by a finger or the like of an operator. Further, a plurality of terminal accommodating openings 25 are formed in the end portion of the back wall portion 16 of the actuator 21, and shaft portions 22a are provided in the respective terminal accommodating openings 25, so that the shaft portions 22a are respectively formed to extend in the width direction of the connector 1 (the direction perpendicular to the views of FIGS. 4 and 5) and constitute a pivotal shaft 22. The arm portion 54 of each of the terminals 51 is inserted through the terminal accommodating opening 25, the position of the shaft portion 22a within the terminal accommodating opening 25 is determined in the vertical direction by the bottom surface of the distal end section 54b of the arm portion 54 and the top surface of the substrate portion 12, and a front surface of the back wall portion 16a restricts movement thereof towards the back. Moreover, frontward movements of outwardly-projecting shaft portions 22b projecting outward from the side wall portions of the actuator 21 on the back side are limited by the back side end surfaces of hook portions 18a formed in the auxiliary extending portions 18. In other words, the pivotal shaft 22 is positioned by the distal end section 54b of the arm portion 54, the substrate portion 12, the front surface of the back wall portion 16a of the back wall portion 16, and the hook portions 18a of the auxiliary extending portions 18, and pivotally supported by the same. The actuator 21 can change its attitude between the open position and the closed position by pivotal motion about the shaft portions 22a within terminal accommodating openings 25 and the outwardly-projecting shaft portions 22b.

The pivotal shaft 22 includes the shaft portions 22a within terminal accommodating openings 25 and the outwardly-projecting shaft portions 22b. The arm portions 54 of the terminals 51 are not necessarily inserted into all of the terminal accommodating openings 25, and, in the illustrated example, the arm portions 54 of the terminals 51 are inserted into every other terminal accommodating openings 25.

Further, the actuator 21 includes arm accommodating recessed portions 26 which are formed in the bottom surface of the actuator 21, and accommodate the arm portions 54 of the terminals 51 when the actuator 21 comes to the closed position. When the actuator 21 is brought to the closed position, a ceiling surface 26a of each of the arm accommodating recessed portions 26 comes into contact with the top surface of the arm portion 54 and urges the arm portion 54 toward down. Furthermore, the actuator 21 is provided with a front wall portion 27 extending downward from the front edge thereof. The bottom surface of the front wall portion 27 moves to the vicinity of the top surface of the flat plate-like cable 101 inserted in the accommodating space 17 when the actuator 21 comes to the closed position, thus preventing foreign matters such as dust from entering the accommodating space 17, and avoiding a short circuit between the neighboring conductive leads 151 or between the neighboring terminals 51 due to foreign matters.

Moreover, the actuator 21 is provided with actuator-side locking projections 24 formed in the vicinity of the front ends thereof on both sides. When the actuator 21 comes to the closed position, the actuator-side locking projections 24 lock the actuator 21 by being engaged with housing-side locking projections 13a projecting from inner side surfaces of the side wall portions 13 on both sides, preventing the actuator 21 from changing the attitude thereof to the open position.

Next, an operation conducted to connect the flat plate-like cable 101 to the connector 1 will be described.

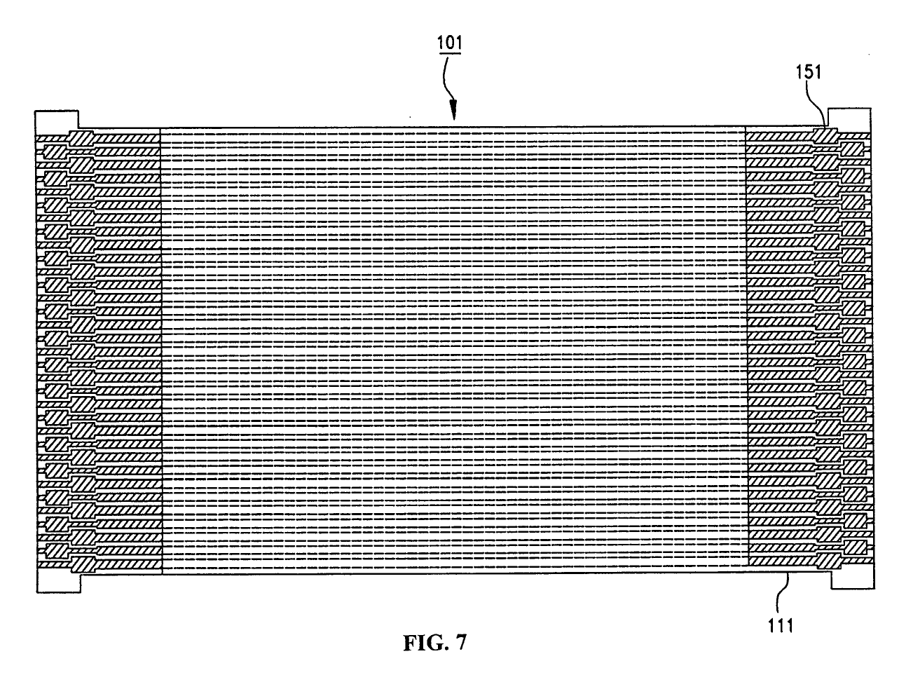

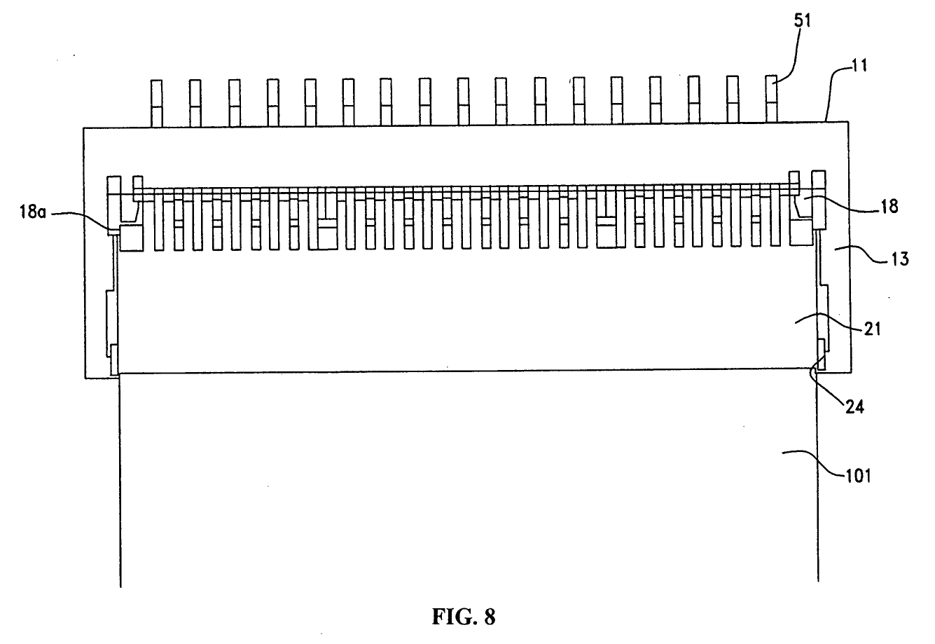

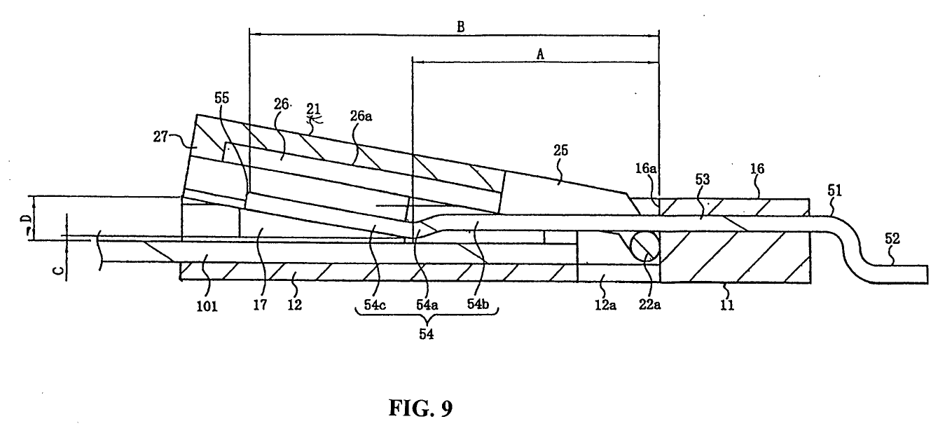

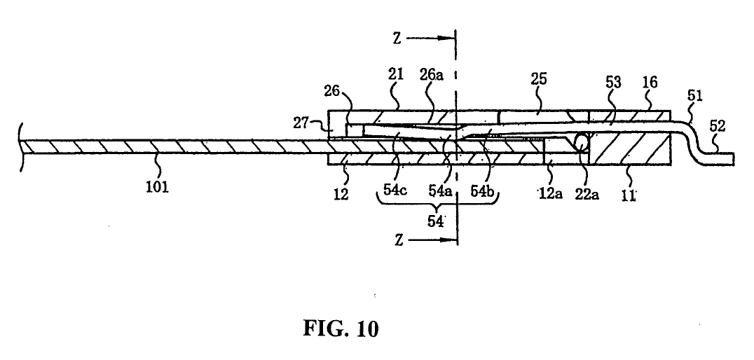

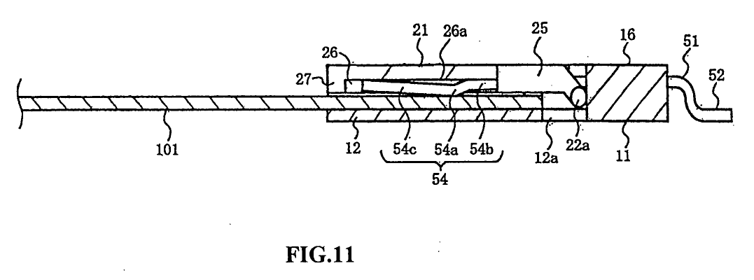

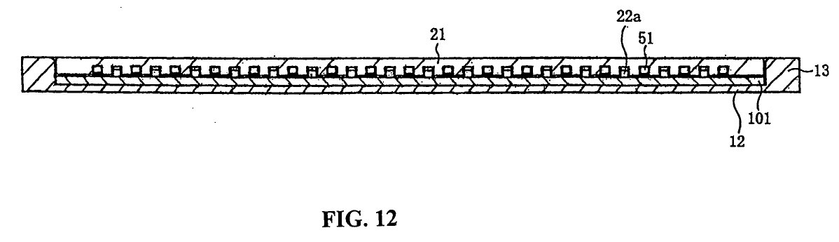

FIG. 7 is a plan view of the flat plate-like cable according to the embodiment of the present invention, FIG. 8 is a plan view showing a state where the flat plate-like cable is inserted into the connector according to the embodiment of the present invention, FIG. 9 is a cross-sectional view, taken along the arrow X-X of FIG. 3, showing the state where the flat plate-like cable is inserted into the connector according to the embodiment of the present invention, FIG. 10 is a first cross-sectional view, taken along the arrow X-X of FIG. 3, showing the state where the flat plate-like cable is connected to the connector according to the embodiment of the present invention, FIG. 11 is a second cross-sectional view, taken along the arrow Y-Y of FIG. 3, showing the state where the flat plate-like cable is connected to the connector according to the embodiment of the present invention, and FIG. 12 is a cross-sectional view taken along the arrow Z-Z of FIG. 10.

As shown in FIG. 7, the flat plate-like cable 101 includes a substrate 111 which has a thin slip-like shape and is an insulating thin plate member, and the plurality of, for example, 33 conductive leads 151 arranged on one surface of the substrate 111. The conductive leads 151 are, for example, foil-like linear members made of conductive metal such as copper, and are arrayed in parallel with each other at a predetermined pitch, for example, approximately 0.1 [mm]. The number and pitch of the conductive leads 151 may be changed as necessary.

It is desirable that the surfaces of the conductive leads 151 on the other side of the substrate are covered or coated with a not-illustrated insulating protective film, and the protective film is removed by peeling only in a predetermined area in the vicinity of an end portion of the flat plate-like cable 101, and the conductive leads 151 are exposed.

When connecting the flat plate-like cable 101 to the connector 1, the end portion of the flat plate-like cable 101 is first inserted into the accommodating space 17 from between the actuator 21 at the open position and the substrate portion 12 of the housing 11, and the flat plate-like cable 101 is positioned so that the conductive leads 151 face the arm portions 54 of the respective terminals 51, and the direction in which the conductive leads 151 extend is in coincidence with the direction in which the terminals 51 extend.

Thereafter, once an operator moves the flat plate-like cable 101 by using his/her finger or the like toward the back side of the housing 11, in other words, toward the back wall portion 16, the front end of the flat plate-like cable 101 comes into abutment against the front end surfaces of auxiliary extending portions 18b. Therefore, the position of the flat plate-like cable 101 is decided in the insertion/removal direction thereof, and comes to the state illustrated in FIGS. 8 and 9.

Next, the operator operates the actuator 21 with his/her finger or the like, and changes the attitude of the actuator 21 which is at the open position as shown in FIGS. 8 and 9 to the closed position as shown in FIGS. 10 and 11. In FIG. 9, if the actuator 21 is changed in its attitude in the counterclockwise direction by pivotal motion, the actuator 21 can be brought to the closed position.

After the actuator 21 comes to the closed position, the ceiling surface 26a of each of the arm accommodating recessed portions 26 abuts on the top surface of the arm portion 54 and urges the arm portion 54 toward down and therefore, each of the arm portions 54 is deformed elastically, and the contact portion 54a is urged against the flat plate-like cable 101 or the conductive lead 151 of it. Accordingly, electrical connection between each of the terminals 51 and each of the conductive leads 151 is well maintained. Moreover, since the actuator-side locking projections 24 are engaged with the housing-side locking projections 13a when the actuator 21 comes to the closed position, the actuator 21 is locked at the closed position. Therefore, the actuator 21 is prevented from changing the attitude thereof to the open position, and the state where the flat plate-like cable 101 is connected to the connector 1 is stably maintained.

In this embodiment, it is to be noted that the terminals 51 can be urged against the flat plate-like cable 101 by the use of elasticity of the end side portions of the terminals 51. In more specific, the actuator 21 comes into contact with the ends of the arm portions 54 of the terminals 51, i.e. the free end portions 55, and urge the terminals 51 toward down. In other words, the points of action of a force applied to the terminals 51 by the actuator 21 are the free end portions 55 of the arm portions 54.

Moreover, the shape of each of the arm portion 54 of each of the terminals 51 in the state before the terminals 51 are urged as shown in FIG. 9, in other words, in the initial state, is as follows: the ratio of distance “D” from the free end portion 55 to the flat plate-like cable 101 to distance “C” from the contact portion 54a to the flat plate-like cable 101 is equal to or larger than the ratio of length “B” of the distal end section 54b and the free end section 54c from the front surface of the back wall portion 16a to the free end portion 55 in each of the terminals 51 to length “A” of the distal end section 54b from the front surface of the back wall portion 16a to the contact portion 54a in each of the terminals 51. This is expressed as the following equation (1):

D/C≧B/A Equation (1)

The equation (1) is a simplified expression of the relationship among “A”, “B”, “C” and “D” which realizes an effective spring action which is produced as the portion between the contact portion 54a and the free end portion 55 bends after the contact portion 54a comes into contact with the flat plate-like cable 101, rather than a spring action produced as the distal end section 54b defined as a working length from the front surface of the back wall portion 16a to the contact portion 54a in each of the terminals 51 bends.

Further, although the lengths of the distal end section 54b and the free end section 54c can be set appropriately, it is desirable that both lengths thereof are approximately equal to each other. In other words, it is preferred that the value of B/A is approximately 2.

As will be understood from this equation, if the distance “C” is reduced, the distal end section 54b is hardly deformed, and only the free end-side portion 54c is substantially deformed, when the attitude of the actuator 21 is changed from the open position to the closed position. Therefore, an upward repulsive force that the actuator 21 receives from the terminals 51 is only a force necessary to elastically deform the free end-side arm portions 54c, and thus becomes small.

In other words, the only upward repulsive force is a force generated when each of the contact portions 54a changes the position thereof with a predetermined amount after each of the contact portions 54a comes into contact with the flat plate-like cable 101, and there is no repulsive force against flexure of the entire terminal 51 before the contact portion 54a comes into contact with the flat plate-shaped cable 101. Therefore, a repulsive force can be substantially reduced.

Further, when the value of the distance “C” is within the range of the equation (1), a similar effect can be obtained since sufficient flexure of the free end section 54c can be secured after the contact portion 54a comes into contact with the substrate.

As a result, since only a small force is necessary to operate the actuator 21, it becomes easier to operate the actuator 21. Also, since the actuator 21 is not deformed without increasing the physical strength thereof, the thickness of the actuator 21 can be reduced. Hence, the thicknesses and sizes of the actuator 21 and thus, those of the connector 1 can be reduced. Furthermore, since the dimension of the actuator 21 in the width direction thereof can be increased, multi-way construction of the connector 1 is feasible as well by increasing the number of terminals 51. Furthermore, since only a small amount of force is necessary for locking the actuator 21 at the closed position, the actuator-side locking projections 24 and the housing-side locking projections 13a are not deformed even without increasing the physical strengths thereof, and this enables the actuator-side locking projections 24 and the housing-side locking projections 13a to be lessened in the respective sizes thereof, and they do not use any extra space to be mounted.

Moreover, since the length “B” from the front surface of the back wall portion 16a to the free end portion 55 in each of the terminals 51 is larger than the length “A” from the front surface of the back wall portion 16a to the contact portion 54a in each of the terminals 51, a force applied to urge the contact portion 54a towards the flat plate-like cable 101 is larger than a force applied to each of the terminals 51 by the actuator 21, due to the principle of leverage. Therefore, the urging force that the contact portion 54a applies to the flat plate-like cable 101 is large, ensuring that electrical connection between the terminals 51 and the conductive leads 151 of the flat plate-like cable 101 is maintained, and that the state where the flat plate-like cable 101 is connected to the connector 1 is maintained. Furthermore, since the contact portion 54a is urged against the flat plate-like cable 101 by the urging force generated as the free end section 54c is elastically deformed, even if there is a variation in the thickness of the flat plate-like cable 101, any displacement due to the variation can be absorbed. Yet further, even if there is variation in the thickness of the actuator 21, displacement due to the variation can be absorbed with the same reason as above.

Moreover, upward displacement of the shaft portions 22a within terminal accommodating openings 25 of the actuator 21 is restricted by the distal end-side arm portions 54b of the arm portions 54, in other words, the shaft portions 22a within terminal accommodating openings 25 of the actuator 21 are latched by the distal end-side arm portions 54b. Therefore, a force necessary for keeping the actuator 21 in engagement with the housing 11 during changing of the attitude of the actuator 21 from the open position to the closed position is dispersed so as to be distributed to the plurality of shaft portions 22a within terminal accommodating openings 25. Hence, since the actuator 21 is not deformed even if the physical strength thereof is not increased, the thickness of the actuator 21 may be reduced. Since the shaft portions 22a within terminal accommodating openings 25 are caught at the roots of the distal end-side arm portions 54b, in other words, at the portions of the terminals 51 projecting from the front surface of the back wall portion 16a, the distal end-side arm portions 54b are kept reluctant to be deformed even if a repulsive force from the shaft portions 22a within terminal accommodating openings 25 is applied. Moreover, since the root of each of the distal end-side arm portions 54b corresponds to a fulcrum when each of the arm portions 54 is considered as a lever, a force for urging the contact portion 54a against the flat plate-like cable 101 does not diminish even if a repulsive force is applied by the shaft portions 22a within terminal accommodating openings 25.

As described above, in the present embodiment, the actuator 21 urges the terminals 51 towards the flat plate-like cable 101 by using elasticity exhibited the free end portions 55, i.e., the front end side portions of the terminals 51. Hence, a force applied to the actuator 21 is reduced and dispersibly distributed, and therefore, the flat plate-like cable 101 can be easily connected to the connector 1 without failure, even with a simple structure. Furthermore, deformation of the actuator 21 can be prevented, a multi-way construction of the connector 1 is feasible by increasing the width thereof, and the thickness and size of the connector 1 can be simultaneously reduced.

Further, each of the terminals 51 is provided with the distal end portion 53 held by the housing 11, and the elastically-deformable arm portion 54 connected to the distal end portion 53 and extending into the accommodating space 17, the arm portion 54 includes the contact portion 54a projecting towards the flat plate-like cable 101 when the latter is inserted in the accommodating space 17, and the ratio of distance “D” from the free end portion 55 of the arm portion 54 to the flat plate-like cable 101 to distance “C” from the contact portion 54a to the flat plate-like cable 101 is equal to or larger than the ratio of length “B” from the front surface of the back wall portion 16a to the free end portion 55 in each of the terminals 51 to length “A” from the front surface of the back wall portion 16a to the contact portion 54a in each of the terminals 51. Therefore, when the attitude of the actuator 21 is changed from the open position thereof to the closed position thereof, the distal end section 54b will be reluctant to be deformed, and only the free end section 54c is substantially deformed. Hence, the only upward repulsive force that the actuator 21 receives from the terminals 51 is a force merely necessary for elastically deforming the free end section 54c, and thus is small. As a result, only a small amount of force is required for operating the actuator 21, which renders the operation of the actuator 21 easier, and also makes it possible to reduce the thickness of the actuator 21.

Moreover, the actuator 21 is provided with the shaft portions 22a within the terminal accommodating openings 25 and the outwardly-projecting shaft portions 22b at one end thereof, which are latched by the distal end-side arm portions 54b. Therefore, a force for keeping the actuator 21 in engagement with the housing 11 during changing of the attitude of the actuator 21 from the open position to the closed position is dispersed to the plurality of shaft portions 22a within terminal accommodating openings 25 and the outwardly-projecting shaft portions 22b.

The present invention is not limited to the above-described embodiment, and may be changed in various ways based on the gist of the present invention, and these changes are not eliminated from the scope of the present invention.

What is claimed is:

1. A cable connector comprising:
a housing provided with an insertion opening into which a cable is inserted;
a plurality of terminals mounted on the housing and configured to be electrically connectable to conductive leads of the cable, each of the terminals having a terminal retention portion engaging the housing and an elastically-deformable arm portion connected to the terminal retention portion and extending into the insertion opening, the arm portion including a contact portion protruding towards said cable upon insertion of said cable into the insertion opening, a free end portion located at an extreme end thereof, said arm defining a free end section between said contact portion and said free end portion, and a distal end section between said contact portion and said terminal retention portion, wherein each of said free end sections and said distal end sections have a length and the length of said free end section is equal to or greater than the length of said distal end section; and
an actuator mounted on the housing and movable between a first operative position at which the cable may be inserted/removed, and a second operative position at which respective ones of the conductive leads of the cable and respective ones of the terminals are electrically connected to one another, wherein
the actuator urges the contact portion of each terminal towards the cable upon insertion of said cable into said insertion opening and movement of said actuator from said first operative position to said second operative position.

2. The cable connector according to claim 1, the actuator engages each arm portion along a portion of said free end section to apply an urging force on the terminals.

3. The cable connector according to claim 1, wherein the actuator engages each arm portion at a first location along a portion of said free end section and at a second location along a portion of said distal end section to apply an urging force on the terminals.

4. The cable connector according to claim 3, wherein said first location is immediately adjacent said free end portion.

5. The cable connector according to claim 4, wherein said second location is immediately adjacent said contact portion.

6. The cable connector according to claim 3 wherein said free end section and said distal end section are each linear and extend at angles to each other.

7. The cable connector according to claim 1, wherein the actuator is provided with a pivotal shaft, the pivotal shaft being supported by a bottom surface of the distal end section of each terminal when the actuator is at the second operative position.

8. The cable connector according to claim 3, wherein the actuator is provided with a pivotal shaft for allowing the actuator to be pivotally moved thereby changing the attitude thereof between the first operative position and the second operative position, and the pivotal shaft supports, together with the distal end section, a repulsive force generated when the actuator at the second position applies an urging effect to the free end portions of the terminals.

9. A cable connector comprising:
a housing provided with an insertion opening into which a cable is inserted;
a plurality of terminals mounted on the housing and configured to be electrically connectable to conductive leads of the cable, each of the terminals having a terminal retention portion engaging the housing and an elastically-deformable arm portion connected to the terminal retention portion and extending into the insertion opening, the arm portion including a contact portion protruding towards said cable upon insertion of said cable into the insertion opening, a free end portion located at an extreme end thereof, said arm defining a free end section between said contact portion and said free end portion and a distal end section between said contact portion and said terminal retention portion; and
an actuator mounted on the housing and movable between a first operative position at which the cable may be inserted/removed, and a second operative position at which respective ones of the conductive leads of the cable and respective ones of the terminals are electrically connected to one another, wherein
the actuator urges the contact portion of each terminal towards the cable upon insertion of said cable into said insertion opening and movement of said actuator from said first operative position to said second operative position;
wherein said urging of said actuator creates two forces on said terminal, a first force generated by engagement of said free end section by said actuator and a second force generated by engagement of said distal end section by said actuator, said first force being greater than said second force.

10. The cable connector according to claim 9, wherein the actuator engages each arm portion at a first location along a portion of said free end section and at a second location along a portion of said distal end section.

11. The cable connector according to claim 10, wherein said first location is immediately adjacent said free end portion.

12. The cable connector according to claim 11, wherein said second location is immediately adjacent said contact portion.

13. The cable connector according to claim 9, wherein said free end section and said distal end section are each linear and extend at angles to each other.

14. The cable connector according to claim 9, wherein the actuator is provided with a pivotal shaft, the pivotal shaft being supported by a bottom surface of the distal end section of each terminal when the actuator is at the second operative position.

15. The cable connector according to claim 9, wherein the actuator is provided with a pivotal shaft for allowing the actuator to be pivotally moved thereby changing the attitude thereof between the first operative position and the second operative position, and the pivotal shaft supports, together with the distal end section, a repulsive force generated when the actuator at the second position applies an urging effect to the free end portions of the terminals.
